(19) United States
(12) Patent Application Publication
(10) Pub. No.: US 2023/0219101 A1
(43) Pub. Date: Jul. 13, 2023

(54) FLUID PIPE MAGNETIZATION UNIT AND FLUID PIPE MAGNETIZATION DEVICE WITH THE SAME

(71) Applicant: Emio-Yu Intellectual Property Consulting Co., Ltd., Hsinchu County (TW)

(72) Inventors: Ching-Ho YU, Hsinchu County (TW); Yung-Hsiang WANG, Hsinchu County (TW); Chih-Chieh MO, Hsinchu County (TW)

(21) Appl. No.: 17/664,225

(22) Filed: May 20, 2022

(30) Foreign Application Priority Data
Jan. 10, 2022 (TW) 111101015

(51) Int. Cl. B03C 1/28; H01F 13/00

(52) U.S. Cl. CPC B03C 1/28; H01F 13/00; B03C 2201/18; B03C 2201/24

(57) ABSTRACT

A fluid pipe magnetization unit includes a ferromagnetism casing, a plurality of magnetic rods, and at least one flow limiting element. The magnetic rods include at least one first magnetic rod and at least one second magnetic rod. Inner elements of the first magnetic rod and the second magnetic rod are alternately positioned with opposite magnetic poles in the ferromagnetism casing. The at least one flow limiting element is arranged in at least one weak magnetic area in the ferromagnetism casing to prevent fluid from flowing through the at least one weak magnetic area. In addition, a fluid pipe magnetization device with the same is also disclosed herein.

### RELATED APPLICATIONS

This application claims priority to Taiwan Application Serial Number 111101015, filed Jan. 10, 2022, the disclosures of which are incorporated herein by reference in their entireties.

### BACKGROUND

### Technical Field

The present disclosure relates to a fluid pipe magnetization unit. More particularly, the present disclosure relates to a fluid pipe magnetization device with a fluid pipe magnetization unit.

### Description of Related Art

When water passes through a vertical magnetic field under a predetermined magnetic strength, some water molecules connected by hydrogen bonding are broken so as to separate the larger water molecule groups into a plurality of smaller water molecule groups. In addition, the physical properties such as the permeability, chemical solubility and surface tension of the smaller water molecule groups are all enhanced.

In industrial fields, a small amount of boiler water is initially treated with a magnetic field to reduce the boiler scale, and industrial water can also be magnetized to achieve functions such as anti-scaling, descaling, sterilization, and algae removal.

Nowadays, the application fields of magnetized water are constantly increasing. For example, in some application fields such as chemical industry, agriculture, construction, etc., there are a lot of exemplary applications of using magnetized water to improve the status quo. In recent years, the food and pharmaceutical industries have also begun to use magnetized water to improve human health. Fluid magnetizers are also widely used in the treatment of oil products, including gasoline, diesel, and kerosene. The fluid magnetization effect may include increasing the fluidity of oil, inhibiting the proliferation of bacteria, improving combustion efficiency, and reducing the generation of exhaust gases after combustion so as to achieve the benefits of energy saving and environmental protection.

However, some defects, such as insufficient magnetic field strength or difficult installation, may often bring trouble to users while using a traditional fluid magnetizer. There is a need to improve the magnetic field strength of the fluid magnetizer so as to further improve efficiency and quality of the fluid magnetizer.

### SUMMARY

One aspect of the present disclosure is a fluid pipe magnetization unit to effectively increase the magnetization intensity of the fluid flowing in a fluid pipeline.

According to some embodiments of the present disclosure, a fluid pipe magnetization unit includes a ferromagnetism casing, a plurality of magnetic rods, and at least one flow limiting element. The magnetic rods includes at least one first magnetic rod and at least one second magnetic rod, the at least one first magnetic rod and the at least one second magnetic rod are alternately positioned in the ferromagnetism casing and magnetic poles of the at least one first magnetic rod are opposite to magnetic poles of the at least one second magnetic rod. The flow limiting element is disposed in a weak magnetic area caused by an arrangement of the magnetic rods to prevent a fluid from flowing through the weak magnetic area.

In some embodiments, the magnetic rods include two first magnetic rods and two second magnetic rods positioned alternately to form a 2×2 matrix arrangement in the ferromagnetism casing and the at least one flow limiting element is disposed in the weak magnetic area located between the magnetic rods.

In some embodiments, the magnetic rods include five first magnetic rods and four second magnetic rods positioned alternately to form a 3×3 matrix arrangement in the ferromagnetism casing and the at least one flow limiting element includes four flow limiting elements to be disposed in the weak magnetic area located between the magnetic rods.

In some embodiments, the at least one flow limiting element includes a magnetic field strength measuring component.

In some embodiments, the at least one flow limiting element includes a temperature measuring component.

In some embodiments, the at least one flow limiting element includes a heating or cooling pipe.

In some embodiments, the at least one flow limiting element includes an ultraviolet lamp.

In some embodiments, the at least one flow limiting element includes an ozone discharge pipe.

In some embodiments, the at least one flow limiting element includes a flow limiting protrusion.

In some embodiments, the at least one flow limiting element includes a flow limiting corner.

In some embodiments, the at least one first magnetic rod includes a non-ferromagnetism sleeve, a plurality of first magnets, a plurality of second magnets, a plurality of ferromagnetism metal sheets and two magnetic rod covers. The first magnets and the second magnets are alternately disposed in the non-ferromagnetism sleeve, and the first magnets and the second magnets are configured with opposite poles. The ferromagnetism metal sheets are respectively disposed between the first magnets and the second magnets, and two ends of the magnetic rod. In addition, two magnetic rod covers seal two ends of the non-ferromagnetism sleeve.

In some embodiments, the fluid pipe magnetization unit further includes two magnetic rod fixing plates respectively fixed on two ends of the fluid pipe magnetization unit to fix the magnetic rods and the at least one flow limiting element.

In some embodiments, the ferromagnetism metal sheets are a plurality of pure iron sheets, the two magnetic rod cover are two non-ferromagnetism cover, the first magnets and the second magnets are NdFeB magnets, and a sum of the first magnets and the second magnets of one of the first magnetic rods is singular.

In some embodiments, the at least one flow limiting element is at least one non-ferromagnetism flow limiting rod.

According to another aspect of the present disclosure, a fluid pipe magnetization device includes a protective shell, two connecting portions and a plurality of foregoing fluid pipe magnetization units.

Hence, the fluid pipe magnetization unit according to the present disclosure can effectively improve the magnetization intensity of the fluid, and can further improve the effective flow rate passing through the fluid pipe magnetization device, thereby further improving the efficiency and quality of the equipment using the fluid pipe magnetization device. In addition, the fluid pipe magnetization unit can directly measure the magnetic field intensity and fluid temperature and other parameters of the fluid by the magnetic field strength measuring component, the temperature measuring component or the like disposed in the flow limiting rod so as to accurately monitor the related parameters of the fluid while flowing through the fluid pipe magnetization unit.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 illustrates a schematic view showing a fluid pipe magnetization unit according to one embodiment of the present invention;

FIG. 2 illustrates a schematic side view showing a fluid pipe magnetization unit of FIG. 1; and

FIG. 3 illustrates a schematic view showing a fluid pipe magnetization device with a fluid pipe magnetization unit according to another aspect of the present invention.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

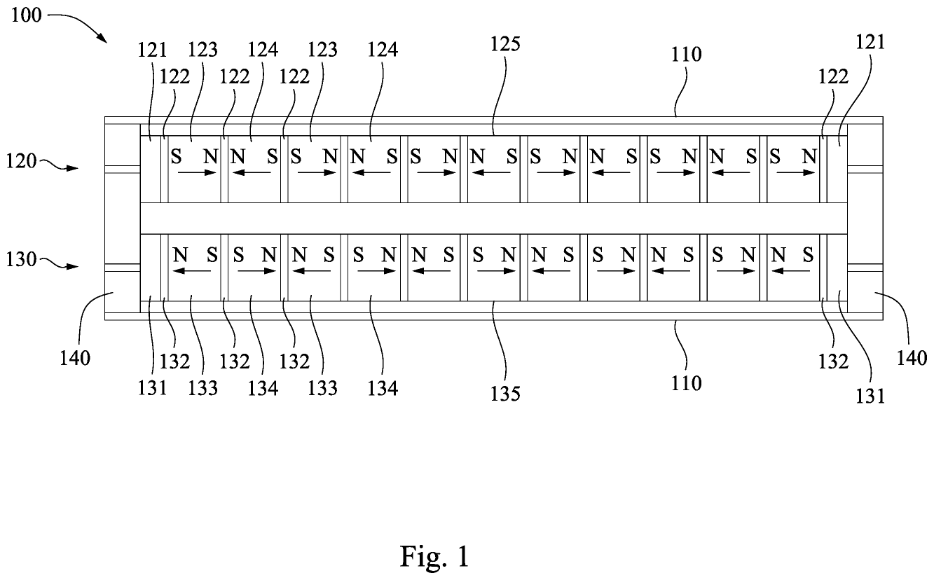

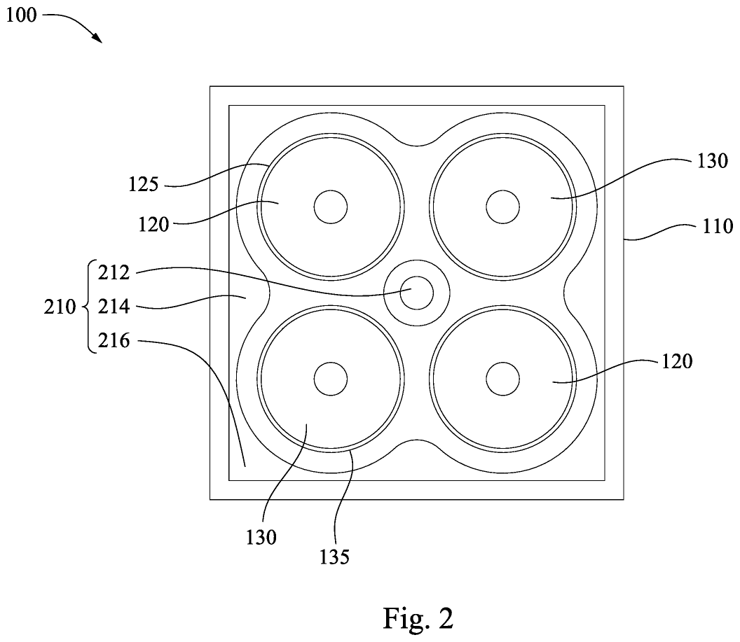

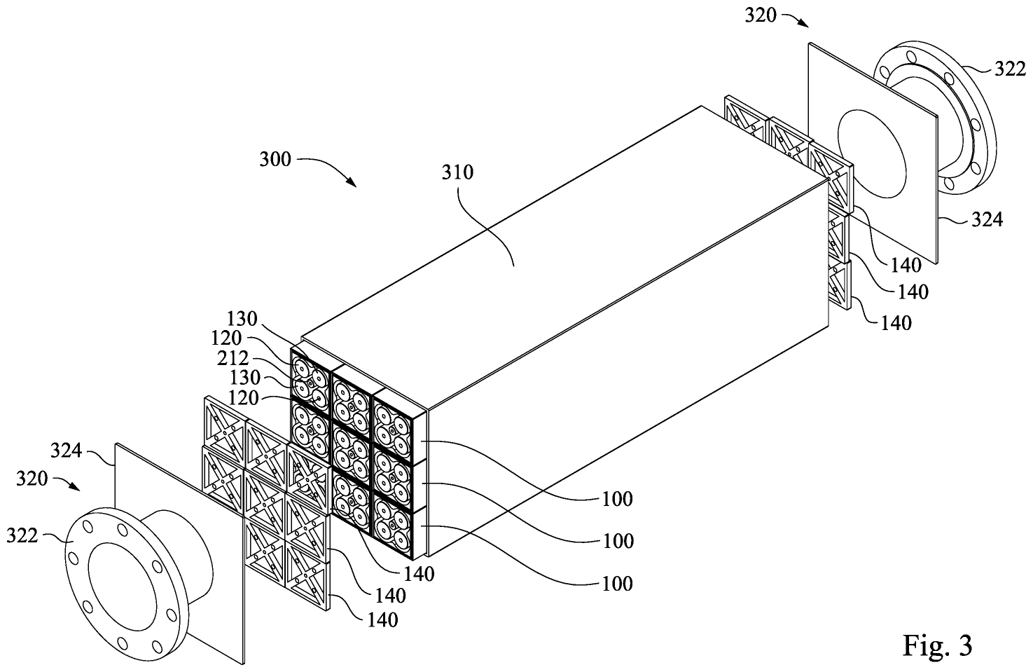

FIG. 1 illustrates a schematic view showing a fluid pipe magnetization unit according to one embodiment of the present invention, and FIG. 2 illustrates a schematic side view thereof. In addition, FIG. 3 illustrates a schematic view showing a fluid pipe magnetization device with a fluid pipe magnetization unit according to another aspect of the present invention.

First referring to FIGS. 1 and 2, the fluid pipe magnetization unit 100 a ferromagnetism casing 110, a plurality of magnetic rods, e.g. first magnetic rods 120 and second magnetic rods 130, and at least one flow limiting element 210. The first magnetic rods 120 and the second magnetic rods 130 are alternately positioned in the ferromagnetism casing 110 and the magnetic poles of the first magnetic rod 120 are opposite to the magnetic poles of the second magnetic rods 130. In addition, the flow limiting element 210 is disposed in a weak magnetic area of the ferromagnetism casing 110 to prevent the fluid from flowing through the weak magnetic area so as to enhance the magnetization intensity of the fluid flowing through the fluid pipe magnetization unit 100. The fluid pipe magnetization unit 100 is equipped with the first magnetic rods 120 and the second magnetic rods 130 having opposite magnetic poles to improve the magnetic field intensity so as to effectively magnetize the fluid flowing near the first magnetic rods 120 and the second magnetic rods 130.

In some embodiments, the magnetic rods include two first magnetic rods 120 and two second magnetic rods 130 positioned alternately to form a 2×2 matrix arrangement in the ferromagnetism casing 110, and the flow limiting element 210 is disposed in the weak magnetic area between the magnetic rods.

In another embodiments, the magnetic rods include five first magnetic rods and four second magnetic rods positioned alternately to form a 3×3 matrix arrangement in the ferromagnetism casing, and four flow limiting elements are disposed in the weak magnetic area between the magnetic rods, without departing from the scope or spirit of the disclosure.

In some embodiments, the flow limiting element 210 includes a flow limiting rod 212 disposed in a position away from the first magnetic rods 120 and the second magnetic rods 130. Since the magnetic field intensity at the position away from the first magnetic rods 120 and the second magnetic rods 130 is lower, the flow limiting rod 212 disposed in this position can prevent the fluid from flowing through a weak magnetic area so as to increase the magnetization intensity of the fluid flowing through the fluid pipe magnetization unit 100.

In some embodiments, a magnetic field strength measuring component or a temperature measuring component can be equipped in the flow limiting rod 212 to measure the magnetic field intensity of the fluid or the fluid temperature so as to monitor the parameters of the fluid flowing through the fluid pipe magnetization unit 100. In some embodiments, the flow limiting rod 212 includes a hollow tube to reduce the cost thereof as well as install various measuring components therein.

In some embodiments, the flow limiting element can be a heating or cooling pipe, an ultraviolet lamp or an ozone discharge pipe. In some embodiments, the flow limiting element may further include a flow limiting protrusion and/or a flow limiting corner, without departing from the scope or spirit of the disclosure.

In some embodiments, the flow limiting rod 212 includes a non-ferromagnetism flow limiting rod, for example, a flow limiting rod made of non-ferromagnetism material such as plastic, non-ferromagnetism stainless steel, aluminum, alloy, aluminum magnesium alloy, etc.

In some embodiments, the flow limiting element 210 further includes a flow limiting protrusion 214 and a flow limiting corner 216, located away from the first magnetic rods 120 and the second magnetic rods 130. Therefore, the fluid can be prevented from flowing through the weak magnetic area with the flow limiting protrusion 214 and the flow limiting corner 216 disposed in the fluid pipe magnetization unit 100 so as to increase the magnetization intensity of the fluid flowing through the fluid pipe magnetization unit 100.

In some embodiments, the first magnetic rods 120 includes a non-ferromagnetism sleeve 125, a plurality of first magnets 123, a plurality of second magnets 124, a plurality of ferromagnetism metal sheets 122 and two magnetic rod covers 121.

The first magnets 123 and the second magnets 124 are alternately disposed in the non-ferromagnetism sleeve 125, and the magnetic poles of the first magnets 123 are opposite to the magnetic poles of the second magnets 124. As shown in FIG. 1, the left sides of the first magnets 123 are S poles and the right sides thereof are N poles, and the left sides of the second magnets 124 are N poles and the right sides thereof are S poles. The first magnets 123 and the second magnets 124 are alternately positioned. In addition, ferromagnetism metal sheets 122 are disposed between the first magnets 123 and the second magnets 124 and two ends of the first magnetic rods 120 to further increase the magnetic field intensity.

In some embodiments, the ferromagnetism metal sheets 122 are metal sheets with high magnetic permeability, such as pure iron metal sheets, low carbon steel metal sheets or high carbon steel metal sheets, etc., without departing from the scope or spirit of the disclosure.

The magnetic rod covers 121 are fixed on two ends of the non-ferromagnetism sleeve 125 so as to seal the foregoing first magnets 123, the second magnets 124 and the ferromagnetism metal sheets 122 in the non-ferromagnetism sleeve 125 to prevent exposure to fluids.

In some embodiments, the sum of the first magnets 123 and the second magnets 124 of the first magnetic rods 120 is singular, and the magnetic pole of one end of the first magnetic rod 120 is opposite to the magnetic pole of another end of the first magnetic rod 120. In addition, the magnetic pole of one end of the second magnetic rod 130 is opposite to the magnetic pole of another end of the second magnetic rod 130.

That is to say, the second magnetic rods 130 includes a non-ferromagnetism sleeve 135, a plurality of second magnets 133, a plurality of first magnets 134, a plurality of ferromagnetism metal sheets 132 and two magnetic rod covers 131. The sum of the second magnets 133 and the first magnets 134 of a second magnetic rod 130 is also singular.

The second magnets 133 and the first magnets 134 are alternately disposed in the non-ferromagnetism sleeve 135, and the magnetic poles of the second magnets 133 are also opposite to the magnetic poles of the first magnets 134. As shown in FIG. 1, the left sides of second magnets 133 are N poles and the right sides thereof are S poles, and the left sides of first magnets 134 are S poles and the right sides thereof are N poles. The first magnets 134 and the second magnets 133 are alternately positioned to increase the magnetic field intensity. In addition, ferromagnetism metal sheets 132 are disposed between the first magnets 134 and the second magnets 133 and two ends of the second magnetic rod 130 to further increase the magnetic field intensity.

In some embodiments, the ferromagnetism metal sheets 132 are metal sheets with high magnetic permeability, such as pure iron metal sheets, low carbon steel metal sheets or high carbon steel metal sheets, etc., without departing from the scope or spirit of the disclosure.

Similarly, the magnetic rod covers 131 are fixed on two ends of the non-ferromagnetism sleeve 135 so as to seal the foregoing first magnets 134, the second magnets 133 and the ferromagnetism metal sheets 132 in the non-ferromagnetism sleeve 135 to prevent exposure to fluids.

In some embodiments, the fluid pipe magnetization unit 100 further includes two magnetic rod fixing plates 140 respectively installed on two ends of the fluid pipe magnetization unit 100 to fix the first magnetic rods 120, the second magnetic rods 130 and the flow limiting element such as the flow limiting rod 212 or the like.

In some embodiments, the magnetic rod cover 121 and the magnetic rod cover 131 are non-ferromagnetism covers. The first magnets 123, the first magnets 134, the second magnets 124 and the second magnets 133 are NdFeB magnets, and preferably N50M NdFeB magnets or above.

In addition, referring to FIG. 3, a fluid pipe magnetization device 300 includes a protective shell 310, two connecting portions 320 and a plurality of fluid pipe magnetization units 100. The connecting portions 320 are fixed on the two ends of the protective shell 310 to be connected in a fluid pipeline, and the fluid pipe magnetization units 100 are installed in the protective shell 310.

In some embodiments, the connecting portion 320 includes a connecting flange 322 and a seal plate 324, the seal plate 324 is connected to the protective shell 310, and the connecting flange 322 is connected to a corresponding connector in the fluid pipeline to guide the fluid into the fluid pipe magnetization units 100 in the protective shell 310. The fluid pipe magnetization device 300 having a plurality of fluid pipe magnetization units 100 can provide a larger flow of fluid, so that the fluid pipe magnetization device 300 can provide required magnetized fluid according to the flow required by the fluid pipeline for operating equipment, without affecting the operation of the equipment.

Accordingly, the fluid pipe magnetization unit according to the present disclosure can effectively improve the magnetization intensity of the fluid, and can further improve the effective flow rate passing through the fluid pipe magnetization device, thereby further improving the efficiency and quality of the equipment using the fluid pipe magnetization device. In addition, the fluid pipe magnetization unit can directly measure the magnetic field intensity and fluid temperature and other parameters of the fluid by the magnetic field strength measuring component, the temperature measuring component or the like disposed in the flow limiting rod so as to accurately monitor the related parameters of the fluid while flowing through the fluid pipe magnetization unit.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A fluid pipe magnetization unit, comprising:
a ferromagnetism casing;
a plurality of magnetic rods, wherein the magnetic rods comprising at least one first magnetic rod and at least one second magnetic rod, the at least one first magnetic rod and the at least one second magnetic rod are alternately positioned in the ferromagnetism casing and magnetic poles of the at least one first magnetic rod are opposite to magnetic poles of the at least one second magnetic rod; and
at least one flow limiting element disposed in a weak magnetic area caused by an arrangement of the magnetic rods to prevent a fluid from flowing through the weak magnetic area.

2. The fluid pipe magnetization unit of claim 1, wherein the magnetic rods comprise two first magnetic rods and two second magnetic rods positioned alternately to form a 2×2 matrix arrangement in the ferromagnetism casing and the at least one flow limiting element is disposed in the weak magnetic area located between the magnetic rods.

3. The fluid pipe magnetization unit of claim 1, wherein the magnetic rods comprise five first magnetic rods and four second magnetic rods positioned alternately to form a 3×3 matrix arrangement in the ferromagnetism casing and the at least one flow limiting element comprises four flow limiting elements to be disposed in the weak magnetic area located between the magnetic rods.

4. The fluid pipe magnetization unit of claim 1, wherein the at least one flow limiting element comprises a magnetic field strength measuring component.

5. The fluid pipe magnetization unit of claim 1, wherein the at least one flow limiting element comprises a temperature measuring component.

6. The fluid pipe magnetization unit of claim 1, wherein the at least one flow limiting element comprises a heating or cooling pipe.

7. The fluid pipe magnetization unit of claim 1, wherein the at least one flow limiting element comprises an ultraviolet lamp.

8. The fluid pipe magnetization unit of claim 1, wherein the at least one flow limiting element comprises an ozone discharge pipe.

9. The fluid pipe magnetization unit of claim 1, wherein the at least one flow limiting element comprises a flow limiting protrusion.

10. The fluid pipe magnetization unit of claim 1, wherein the at least one flow limiting element comprises a flow limiting corner.

11. The fluid pipe magnetization unit of claim 1, wherein the at least one first magnetic rod or the at least one second magnetic rod comprises:
a non-ferromagnetism sleeve;
a plurality of first magnets;
a plurality of second magnets, wherein the first magnets and the second magnets are alternately disposed in the non-ferromagnetism sleeve, and the first magnets and the second magnets are configured with opposite poles;
a plurality of ferromagnetism metal sheets respectively disposed between the first magnets and the second magnets, and two ends of the at least one first magnetic rod; and
two magnetic rod covers sealing two ends of the non-ferromagnetism sleeve.

12. The fluid pipe magnetization unit of claim 11, further comprising:
two magnetic rod fixing plates respectively fixed on two ends of the fluid pipe magnetization unit to fix the magnetic rods and the at least one flow limiting element.

13. The fluid pipe magnetization unit of claim 11, wherein the ferromagnetism metal sheets are a plurality of pure iron sheets, the two magnetic rod covers are two non-ferromagnetism covers, the first magnets and the second magnets are NdFeB magnets, and a sum of the first magnets and the second magnets of the at least one first magnetic rod or the at least one second magnetic rod is singular.

14. The fluid pipe magnetization unit of claim 12, wherein the at least one flow limiting element is at least one non-ferromagnetism flow limiting rod.

15. A fluid pipe magnetization device, comprising:
a protective shell;
two connecting portions respectively disposed on two ends of the protective shell to be connected in a fluid pipeline; and
a plurality of fluid pipe magnetization units equipped in the protective shell, wherein each of the fluid pipe magnetization units comprises:
a ferromagnetism casing;
a plurality of magnetic rods, wherein the magnetic rods comprising at least one first magnetic rod and at least one second magnetic rod, the at least one first magnetic rod and the at least one second magnetic rod are alternately positioned in the ferromagnetism casing and magnetic poles of the at least one first magnetic rod are opposite to magnetic poles of the at least one second magnetic rod; and
at least one flow limiting element disposed in a weak magnetic area caused by an arrangement of the magnetic rods to prevent a fluid from flowing through the weak magnetic area.

16. The fluid pipe magnetization device of claim 15, wherein the magnetic rods comprise two first magnetic rods and two second magnetic rods positioned alternately to form a 2×2 matrix arrangement in the ferromagnetism casing and the at least one flow limiting element is disposed in the weak magnetic area located between the magnetic rods.

17. The fluid pipe magnetization device of claim 15, wherein the magnetic rods comprise five first magnetic rods and four second magnetic rods positioned alternately to form a 3×3 matrix arrangement in the ferromagnetism casing and the at least one flow limiting element comprises four flow limiting elements to be disposed in the weak magnetic area located between the magnetic rods.

18. The fluid pipe magnetization device of claim 15, wherein the at least one flow limiting element comprises a magnetic field strength measuring component, a temperature measuring component, a heating or cooling pipe, an ultraviolet lamp, an ozone discharge pipe, a flow limiting protrusion or a flow limiting corner.

19. The fluid pipe magnetization device of claim 15, wherein the at least one first magnetic rod or the at least one second magnetic rod comprises:
a non-ferromagnetism sleeve;
a plurality of first magnets;
a plurality of second magnets, wherein the first magnets and the second magnets are alternately disposed in the non-ferromagnetism sleeve, and the first magnets and the second magnets are configured with opposite poles;
a plurality of ferromagnetism metal sheets respectively disposed between the first magnets and the second magnets, and two ends of the at least one first magnetic rod; and
two magnetic rod covers sealing two ends of the non-ferromagnetism sleeve.

20. The fluid pipe magnetization device of claim 19, wherein the ferromagnetism metal sheets are a plurality of pure iron sheets, the two magnetic rod covers are two non-ferromagnetism covers, the first magnets and the second magnets are NdFeB magnets, and a sum of the first magnets and the second magnets of the at least one first magnetic rod or the at least one second magnetic rod is singular, and the at least one flow limiting element is at least one non-ferromagnetism flow limiting rod.
